(19) United States
(12) Patent Application Publication
(10) Pub. No.: US 2014/0362714 A1
(43) Pub. Date: Dec. 11, 2014

(54) NETWORK-SELECTING HYBRID FIBER COAXIAL MONITOR, SYSTEM INCLUDING SAME AND METHOD OF EMPLOYING

(71) Applicant: CHEETAH TECHNOLOGIES, L.P., Pittsburgh, PA (US)

(72) Inventors: STEVE A. DAY, PITTSBURGH, PA (US); STANFORD L. SOUTHERN, SEWICKLEY, PA (US); MARK ROBERT BEREIT, LATROBE, PA (US); MICHAEL T. MCELHINNY, CORAOPOLIS, PA (US)

(73) Assignee: CHEETAH TECHNOLOGIES, L.P., Pittsburgh, PA (US)

(21) Appl. No.: 14/300,806

(22) Filed: Jun. 10, 2014

Related U.S. Application Data
(60) Provisional application No. 61/833,074, filed on Jun. 10, 2013.

(51) Int. Cl. H04L 12/26

(52) U.S. Cl. CPC H04L 43/50
USPC 370/252

(57) ABSTRACT

A device for monitoring a hybrid fiber coaxial network. The device includes a processing device and a switching mechanism in communication with, and controlled by, the processing device. The processing device is structured to receive data related to the hybrid fiber coaxial network and communicate the data via at least one of a plurality of communication pathways. The switching mechanism is structured to select from among the communication pathways the at least one pathway along which the data from the processing device is communicated in accordance with logic carried out by the processing device. The plurality of communication pathways comprises a communication pathway other than the hybrid fiber coaxial network.

### CLAIM TO PRIORITY

This patent application claims the priority benefit under 35 U.S.C. §119(e) of U.S. Provisional Application No. 61/833,074 filed on Jun. 10, 2013, and entitled, “Network-Selecting Hybrid Fiber Coaxial Monitor (NS-HFCM)”, the contents of which are hereby incorporated herein by reference.

### BACKGROUND

1. Field of the Invention

The present invention relates to methods and devices for monitoring cable television Hybrid Fiber Coax (HFC) networks and, more particularly, to methods, devices and systems which provide for remote monitoring of such networks.

2. Background Information

Remote monitoring, or telemetry, includes status monitoring and network performance monitoring. Status Monitoring is the process of monitoring network elements within a Hybrid Fiber Coax (HFC) Network. Examples of network elements include, but are not limited to, devices such as HFC optical nodes, RF amplifiers, Cable Television (CATV) power supplies, CATV backup power supplies, and head-end devices, as well as Network Interface Devices (NID) such as demarcation boxes, as well as Customer Premises Equipment (CPE) such as set top boxes. Status monitoring provides communications with, and remote monitoring of, a network element. Status monitoring may allow for remote control of the network element, and may allow the network element to remotely alarm. The status monitor interacts with the network element operational configuration through internal sensors, communications with the network element, or some combination of both, depending upon the specific application.

Network performance monitoring is the process of monitoring the RF Spectral data, or providing deep packet inspection (DPI), or providing deep content inspection (DCI), or a combination of these. Types of RF spectral measurements include, but are not limited to, frequency allocation, bandwidth, Quadrature Amplitude Modulation (QAM) constellations, error vector magnitude, visual/aural separation, micro-reflection analysis, channel signal levels, spectral analysis, group delay, spectrum tilt, phase noise, and gain compression. DPI and DCI analyze the communications content carried on the RF channels to measure things such as, but not limited to, data rates, and error rates such as Modulation Error Rate (MER), Code-word Error Rate (CER), and Bit Error Rate (BER), as well as MPEG analysis such as header integrity, PID inspection, and sync errors.

Conventional status monitors, such as the Cheetah CMD-N, monitor network elements in the HFC network. The CMD-N, and Cheetah's other similar monitors, monitor HFC optical nodes within the network. In monitoring these optical nodes, the CMD-N also gathers inferential data that conveys the health of the entire fiber optic network. The Cheetah CMD-P Plus, and Cheetah's other similar status monitors, monitor HFC CATV power supplies and CATV backup power supplies within the network. In monitoring these CATV power supplies, the CMD-P Plus also gathers inferential data that conveys the health of the HFC network power, the individual batteries, generators, and other components that impact the CATV power supply (or backup CATV power supply). Network performance monitors, such as the Cheetah Network Tracker Plus, monitor the RF spectrum of the HFC network, provide DPI or DCI information, or a combination of these. In performance monitoring, anywhere in the network from origin to end of line, the monitors provide detailed RF and DPI/DCI data about that mission critical point in the network.

The prior art devices communicate over the HFC network, so they are reliant on the HFC network in order to monitor the HFC network itself. Hence, if the HFC network is down, the monitor is not able to communicate anymore. Ironically, during such instance is when the monitoring data is likely to be of the most use to Network Operators. Embodiments of the present invention include the capability to communicate over at least two diverse communications pathways. This allows such embodiments to continue providing monitoring capabilities no matter what state the HFC Network is in.

The prior art devices also require a reliable external power source, whether it is commercial power or network elements such as CATV backup power supplies, or generators. CATV backup power supplies exist to maintain power on the HFC network in the event of a network power outage. However, they power several components in the cable network, so they are in no way devoted to keeping the monitors running Embodiments of the present invention include the ability to be powered separately from the HFC network so that they can continue to operate in the event of an HFC network power outage.

Prior art devices in other fields (outside of cable) make use of secondary communications paths, but in a much more simplistic manner. For instance, cell phones will select Wi-Fi (vs. cellular connection) when available, to allow a cheaper communication path for data transfer. Embodiments of the present invention employ logic which is much more robust and allows for a broader set of criteria for network selection.

For the remainder of this disclosure, both status monitoring and network performance monitoring, whether carried out locally or remotely, will be referred together as “monitoring”, and the devices which accomplish the monitoring will be referred to as a “monitoring device”, a “monitor”, or by the acronym “NS-HFCM”. Each “monitor” may be attached to a network element, internal to a network element, or may be a standalone device. A standalone device does not require any interaction or connection with a network element.

### SUMMARY OF THE INVENTION

Embodiments of the present invention offer a number of novel features. Among such novel features two are of particular note. First, a device in accordance with the present invention (hereinafter referred to as the “NS-HFCM”) is the first monitor, integrated circuit, communications module, functional device, or ‘split horizon’ functional device to include a self-aware capability to use multiple communication pathways for remote monitoring capabilities in a HFC network. (A split horizon device is defined as the case where a monitor already exists and then multiple communication pathways are subsequently added via a secondary device.) The NS-HFCM allows status monitoring and network performance monitoring within the HFC network to continue, even when the network is not fully operational.

A second novel principle is that the NS-HFCM includes the ability to obtain power from an alternative energy source (which may include a local energy storage device, such as a battery) which mitigates the impact of HFC network power outages, whether the power is sourced from commercial power, power over the network, or power from a network element. The NS-HFCM may utilize regenerative energy sources to allow it to remain operational indefinitely.

As one aspect of the present invention, a device for monitoring a hybrid fiber coaxial network is provided. The device comprises: a processing device structured to receive data related to the hybrid fiber coaxial network and communicate the data via at least one of a plurality of communication pathways; and a switching mechanism in communication with, and controlled by the processing device. The switching mechanism is structured to select from among the communication pathways the at least one pathway along which the data from the processing device is communicated in accordance with logic carried out by the processing device. The plurality of communication pathways comprises a communication pathway other than the hybrid fiber coaxial network.

The logic may be one or both of predefined or defined by a user.

The switching mechanism may be adapted to provide for the processing device to communicate along two or more communication pathways of the plurality of communication pathways at the same time.

The logic may rely on one or more variables that may be internal to or external to the monitor in determining the at least one communication pathway along which the data from the processing device is transmitted.

The one or more variables may comprise one or more of: a power supply data point, a network status data point, an environmental data point, or a data point pertaining to a network element being monitored.

One of the plurality of communications pathways may comprise: a cellular phone network, a Wi-Fi network, or an Ethernet network.

The device may further comprise a power source switching mechanism structured to receive power from a plurality of power sources and selectively allow transmission of the power from a selected one of the power sources to the processing device in accordance with the logic; and at least one of the power sources may comprise a power source other than the hybrid fiber coaxial network.

The at least one power source may comprise a rechargeable battery or a super capacitor.

The rechargeable battery may be structured to be recharged by the hybrid fiber coaxial network.

The rechargeable battery may be structured to be recharged by at least one of solar power or wind power.

The processing device may include a device-specific identifier associated therewith and the processing device may be structured to communicate the identifier via the at least one communication pathway.

As another aspect of the present invention, a system for monitoring a hybrid fiber coaxial network is provided. The system comprises: at least one communication pathway other than the hybrid fiber coaxial network and a monitoring device. The monitoring device comprises: a processing device structured to receive data related to the hybrid fiber coaxial network and communicate the data via at least one of a plurality of communication pathways, the plurality of communication pathways comprising the hybrid fiber coaxial network and at least one communication pathway other than the hybrid fiber coaxial network; and a switching mechanism in communication with, and controlled by, the processing device, the switching mechanism structured to select from among the communication pathways the at least one pathway along which the data from the processing device is communicated in accordance with logic carried out by the processing device.

The logic may rely on one or more variables that may be internal to or external to the monitor in determining the at least one communication pathway along which the data from the processing device is transmitted.

The at least one communication pathway other than the hybrid fiber coaxial network may comprise at least one of: a cellular phone network, a Wi-Fi network, or an Ethernet network.

The system may further comprise at least one power source other than the hybrid fiber coaxial network and a power source switching mechanism controlled by the processing device, wherein the power source switching mechanism is structured to receive power from the hybrid fiber coaxial network and the at least one power source other than the hybrid fiber coaxial network and selectively allow transmission of the power from a selected one of the hybrid fiber coaxial network and the at least one power source other than the hybrid fiber coaxial network to the processing device in accordance with the logic.

The at least one power source other than the hybrid fiber coaxial network may comprise a rechargeable battery or a super capacitor.

The at least one power source other than the hybrid fiber coaxial network may be structured to be recharged by one or more of the hybrid fiber coaxial network, solar power or wind power.

The processing device may include a device-specific identifier associated therewith and the processing device may be structured to communicate the identifier via the at least one communication pathway.

The system may further comprise a network management system which utilizes the common device-specific identifier to combine information or data communicated on two or more communication pathways into one set of information or data.

As yet a further aspect of the present invention, a method of monitoring a hybrid fiber coaxial network is provided. The method comprises: sensing via a number of electronic sensors one or more characteristics of the hybrid fiber coaxial network; and communicating the one or more characteristics via a communication pathway other than the hybrid fiber coaxial network.

### BRIEF DESCRIPTION OF THE DRAWINGS

FIG. 1 shows a logic diagram for network and power selection for a monitoring device in accordance with an example embodiment of the present invention.

FIG. 2 shows an example of ‘cascading’ network selection logic (to select between network A and network B) in accordance with an example embodiment of the present invention.

FIG. 3 shows a schematic depiction of a monitoring device in accordance with an example embodiment of the present invention.

FIG. 4 shows schematic depiction of a system including a monitoring device with multiple networks and multiple power sources connected based on policy generated communications and power logic in accordance with an example embodiment of the present invention.

FIG. 5 shows a schematic depiction of the system of FIG. 4 in an example situation in which there is an outage in the HFC network portion.

FIG. 6 shows a scenario where the network management software (NMS) interfaces with multiple monitors, each with its own network-selection criteria in accordance with an example embodiment of the present invention.

FIG. 7 shows an example with two monitors and three networks, and shows how the NMS uniquely identifies each monitor (using IP addresses) in accordance with an embodiment of the present invention.

### DETAILED DESCRIPTION

As used herein, the term “number” shall be used to refer to any non-zero integer, i.e., one or a quantity greater than one.

Hybrid fiber coaxial networks (HFC) are unique in that they represent the transmission of a single broadband RF signal that may contain hundreds or even thousands of individual communications channels. As discussed above, monitoring devices of an HFC network have traditionally communicated using one or more of those channels. The HFC monitors communicate with network management software (NMS) that allows the Network Operator to monitor remotely. There is an established standard for this communication that can be described as Hybrid Management Sub-Layer (HMS) network monitoring messaging transported via a DOC SIS modem. In the case of a service disruption or an out of service condition, the HFC network may lose its broadband RF signal, and hence all of its RF-based monitoring communication pathways (RF channels).

The problem is that at the very moment that the Network Operator needs to find the most information about the network, all communications with network monitoring is disrupted and valuable information is lost. Examples of this valuable information include, but are not limited to, network fault locations, channel signal levels, RF spectrum abnormalities, and CATV power supply information (commercial power feed, power supply health, backup battery health). Having this valuable monitoring information allows the Network Operator to make more informed decisions such as, for example, without limitation, what type of truck to send to a location for repair, the skill of the technician to send, the urgency of the problem, and how widespread is the problem. Having reduced monitoring information, or none of this information due to limited or no connectivity, diminishes the usability of the monitoring system at perhaps the Network Operator's most important time of need.

Such situation is generally unique to HFC networks. For example, telecommunications networks are designed so that a customer service disruption on a twisted pair does not impact the monitoring communications pathway as the monitoring communications pathway travels on a separate twisted pair. The same analogy is true in cellular networks and power distribution networks. HFC networks and their monitoring solutions have this unique weakness, as compared to other types of service providers.

Embodiments of an NS-HFCM device in accordance with the present invention solve such problem in HFC networks by utilizing two or more separate networks, in a redundant fashion, to communicate and monitor data. Such devices enable alternative networks, outside the control of the cable operator, to be used as a primary means of communication for monitoring information. The advantage of multiple networks is that the NS-HFCM's ability to communicate and monitor is not reliant on the state of the network which it is monitoring, i.e., the HFC network itself

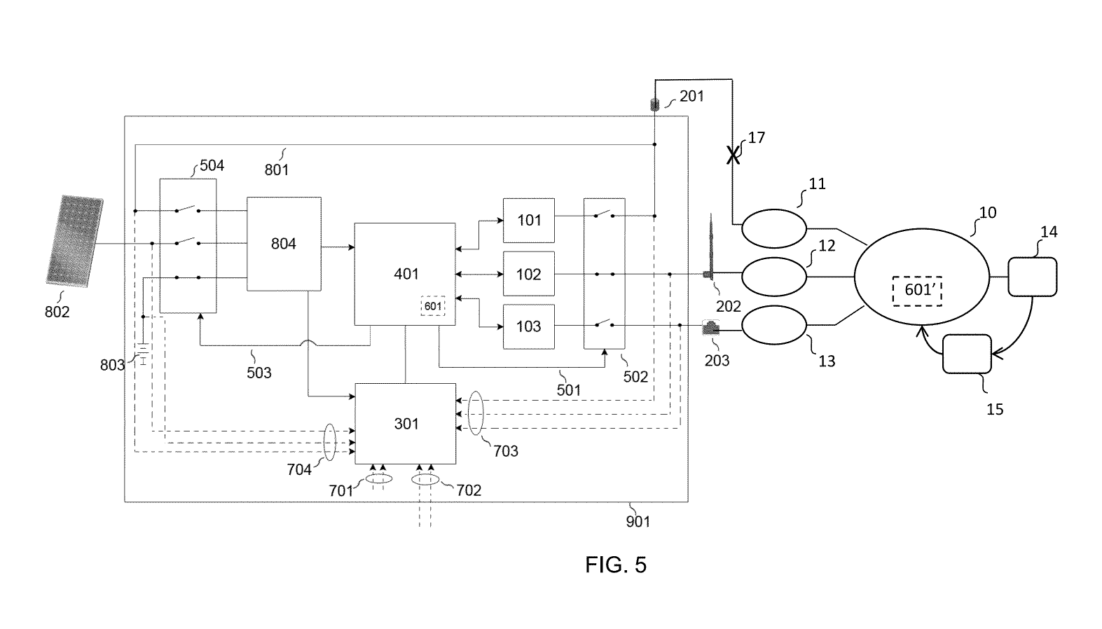

Further, CATV backup power supplies may incidentally provide power to the NS-HFCM device, but the NS-HFCM is not reliant on the CATV backup power supply for power in all circumstances. In accordance with various embodiments of the present invention, the NS-HFCM may have access to at least one alternative power source (e.g., without limitation, internal battery, external solar panel, wind power) that will provide for continued operation of the NS-HFCM in the event that the CATV backup power supply is not available. For example, during a power outage in which access to HFC networked power is lost, the NS-HFCM may rely on an internal storage device (e.g., a battery), which could in turn be recharged by an external power source or network element. Renewable energy sources such as wind or solar may be used to provide indefinite operation to the NS-HFCM and/or recharging of an internal battery. Renewable energy sources may also be used as the primary power source for the device which may then be supplemented, as necessary, by other power sources. Thus, the NS-HFCM is not solely reliant on the CATV network for communications or power. FIG. 3 depicts an example embodiment of an NS-HFCM (device 901) with connections to multiple networks (HFC connection 201, cellular 202, Wi-Fi/ethernet 203) and multiple power sources (e.g., HFC power 801, solar panel(s) 802, rechargeable battery 803) and the associated logic (shown as element 601) for selecting among networks and power sources. FIG. 5 provides an example of an HFC network outage (shown at element 17) that results in use of an alternative communications network (cellular network 202) and an alternative power source (rechargeable battery 803).

Aspects of the present invention cover, but are not limited to, five functional areas: the monitoring devices, the communications pathways, the NMS, the network-selecting logic, and the power-selecting logic.

The first functional area is the NS-HFCM, i.e., the monitoring device (monitor) itself (as depicted by device 901 in the example embodiment of FIG. 3), which comprises one aspect of the present invention. The functional architecture for the monitor 901 starts with a processor core 401 (comprising one or more processors) executing monitoring and communications logic 601 within its code. The processor core 401 is powered by one or more of the power sources 801, 802, 803 via a power supply 804 and interfaces with various inputs and outputs to collect sensory and telemetry data, as well as to perform control operations where appropriate, as is typical for any intelligent telemetry device. The monitoring circuitry that collects the sensory and telemetry data related to the HFC network 201 is shown schematically as device 301 in FIG. 3 and may receive power as needed from one or more of the power sources 801, 802, 803 via power supply 804. The actual sensors and control functions which monitor the HFC network 201 may be a part of the monitor 901 (such shown schematically as input 701 in FIG. 3), or a part of another device or devices external to the monitor 901 with which the monitor 901 communicates (such as shown schematically as input 702 in FIG. 3). The monitoring circuitry 301 collects power source data 704 from each power source, and also collects network performance data 703 from each connected network. The processor core 401 separately interfaces with multiple communications pathways, for the purpose of reporting the sensory and telemetry data to a network management system (NMS), and accepting instructions from the NMS to perform specific controls. The processor core additionally implements specific network-selecting logic (shown schematically as element 601 in FIG. 3) when communicating with the NMS, following the rules configured for its behavior.

The second functional area is the set of communications devices, which includes the modems, radios or other communications devices that represent the multiple communications pathways. These are depicted in the example embodiment of FIG. 3 by devices 101, 102, 103. The communication device is part of this patent, as currently there are no devices that deploy alternative pathways in the process of CATV status monitoring or network performance monitoring. One of the communications pathways within the scope of this patent is the HFC network 201; typically at this time such a pathway utilizes the DOCSIS cable modem standards, although this is not specifically required, and other communications techniques utilizing the HFC network are within the scope of this patent. At least one alternate communications pathway within the scope of this patent is not the HFC network. Possible alternate communications pathways include, but are not limited to, cellular phone networks (FIG. 3, connection 202), Wi-Fi networks and Ethernet networks (FIG. 3, connection 203). The utilized network type or topology is not what makes the invention unique. The use of multiple networks for redundancy in monitoring within the HFC Network is one of the attributes which make the NS-HFCM unique, as well as the NS-HFCM's ability to select which network, or networks, to use. In addition to the normal flow of data traffic between the monitor and the NMS, each communications pathway also provides status to the processor core 401 (via connection 703 in FIG. 3) for the pathway itself, so that the processor core 401 can consider the health of each communications pathway within the determination of which pathway(s) to use for which traffic (the network selection logic). Much of the architecture described here is common and well understood for monitoring devices. The multiple communications pathways (depicted by connections 201, 202, 203 in FIG. 3), and the pathway status information conveyed to the monitor's processor core (connection 703 in FIG. 3), are functional requirements specific to a network-selecting monitor.

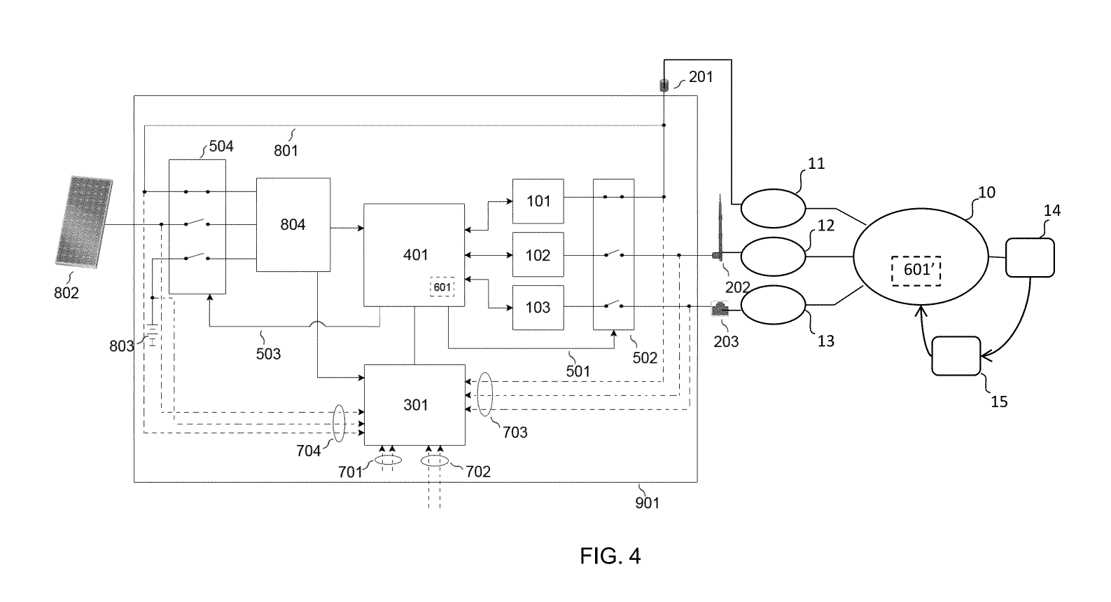

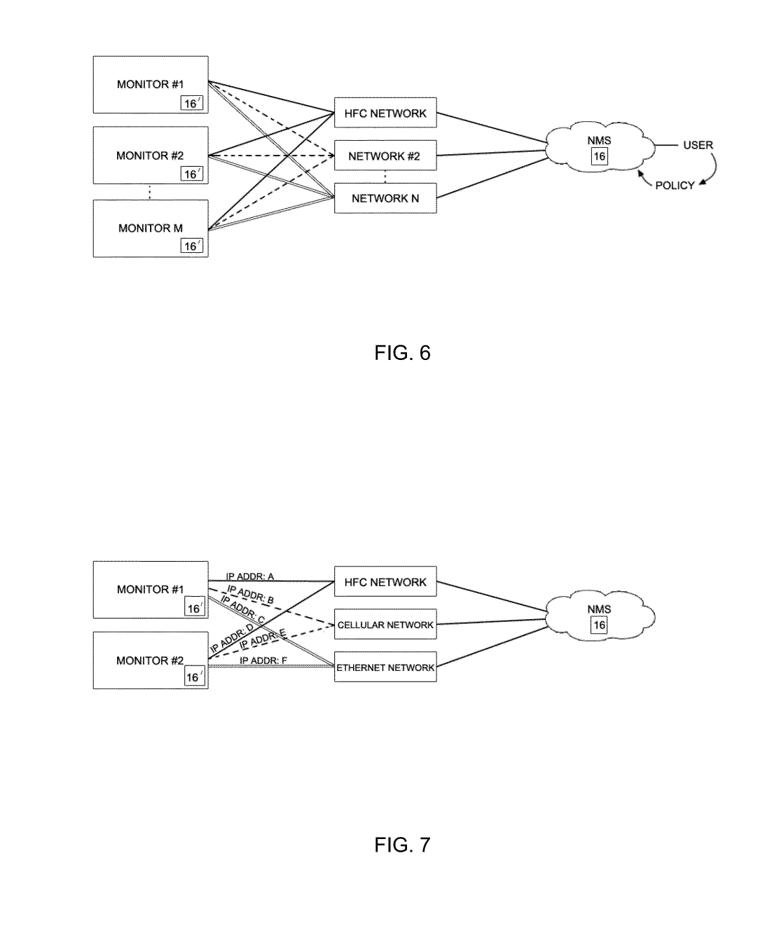

The third functional area is the Network-Selecting NMS (NS-NMS), shown schematically as element 10 in FIG. 4. The functional architecture for the NS-NMS starts with a processor core (one or more processors) executing network management logic within its code (element 16 in FIG. 6). The processor core interfaces with one or more networks through which the various communications pathways may reach it; this “wide area network” may consist of direct or indirect links to the HFC plant, the Internet, and/or various other pathways, using well-understood network communications technology. The processor core separately connects to a storage system (for example, an SQL database stored on one or more hard disk drives) to retain information about the managed devices. The processor core separately presents one or more user interfaces 14 to the individuals concerned with the devices and information managed by this system. The form of user interface presentation could be web pages, proprietary data streams to custom “fat” applications on other computing devices (PCs, tablets, smartphones, etc.), and so on, and the means of communications with the user interface devices may or may not use the same wide area network link(s) as the communications with the remote devices. The architecture above is common and well understood for network management systems. All that is required functionally to support the network-selecting architecture is that the network interface(s) provide some data connection to each of the communications pathways being employed by the network selecting monitor devices (networks 11, 12, 13 in FIG. 4). The NS-NMS's processor core additionally implements specific network selecting logic (element 601′ in FIG. 4, element 16 in FIG. 6) when communicating with, and managing, the devices, following the rules configured for its behavior on specific devices or sets of devices. Each network-selecting monitor must have a unique device identifier, specific to that device, yet reported consistently across all communications pathways, whenever it initiates communications with the NS-NMS. This identifier enables the NS-NMS to identify which network traffic from different network addresses originates from the same monitor, in order to both correctly present a unified view of that monitor and to infer which pathway(s) are operational at a particular time. The NS-NMS does not display multiples of the same monitor. The NS-NMS can also concatenate or combine communications over multiple networks. In other words, the NS-NMS is agnostic with respect to the network from which it receives data. Even if the data is coming from multiple networks, the NS-NMS will combine the data into one useable set of data. FIG. 6 shows the generic scenario of an NS-NMS interfacing with multiple monitors, each with its own network-selection criteria (element 16′), and FIG. 7 a specific example of an NMS uniquely identifying two monitors over three different networks using IP addressing.

The fourth functional area is the network-selecting logic (FIG. 3, element 601), which is another aspect of this patent. The network-selecting logic is contained in the monitor firmware and may also be distributed across one or more communications networks, and possibly also in the NMS, as depicted by element 601′ in FIG. 4. The network-selecting logic provides self-aware, automated switching between alternative communications pathways, as described herein.

The network-selecting capability of the NS-HFCM allows it to select the most desirable of multiple, alternative communications paths, therefore providing the means to send its monitoring data despite an ‘out of service’ condition of the normal means of communications through the HFC network. As shown in the example embodiment of FIG. 3, the network or networks utilized by device 901 is selectable via a network switch 502 which is controlled via network switch control 501 communicated by processor core 401.

The NS-HFCM contains logic to determine which network it will use to communicate its monitoring data. This logic (communication logic') is based on a user-selected (via element 14) or pre-defined policy (element 15 in FIG. 4). The policy may be based on, but not limited to, lowest cost, ‘most available’ network, or other criteria of communications path selection.

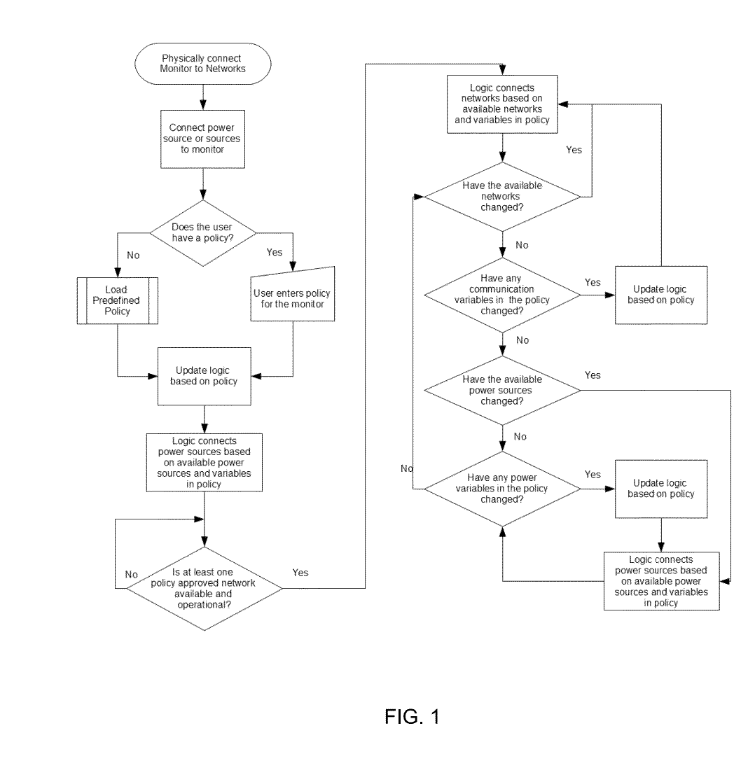

The policy may be entered by the Network Operator through the NMS, or may be predefined by the device manufacturer or Network Operator. The policy may be stored on each NS-HFCM, or in memory located in one or multiple networks. The communication logic may be stored on each NS-HFCM, and some of the logic may be stored in memory located in one or multiple networks and/or in the NMS. FIG. 1 depicts an algorithm for loading the policy and associated communication logic (and power logic) for an NS-HFCM.

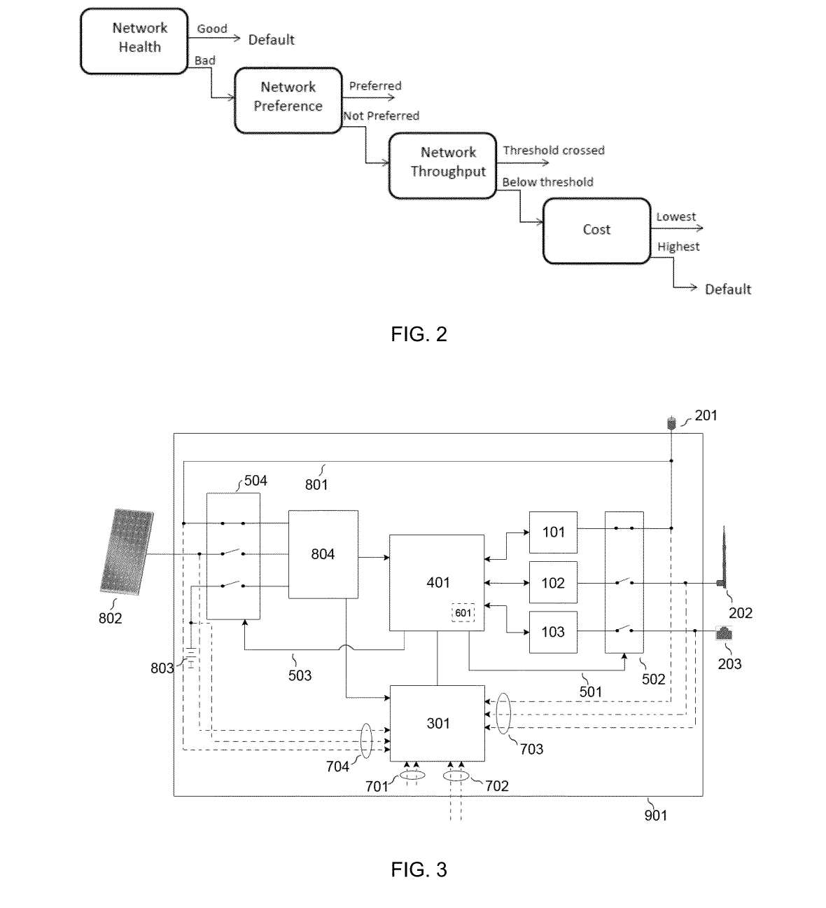

The ability of the NS-HFCM to select which network, or networks, to use may be based on several factors and variables. Network availability is one variable that may be used to determine on which network, or networks, to communicate. Signal integrity and available power are other variables that may be used by the NS-HFCM to select which network, or networks, to use. Cost may be another variable used by the NS-HFCM to select which network, or networks, to use. The customer-defined or pre-determined policy uses these variables to select the network, or networks, to use. FIG. 2 shows an example of the ‘cascading’ network-selecting logic based on various factors and variables, for an NS-HFCM.

In some cases, the NS-HFCM may communicate on more than one network at the same time, or successively.

Additionally, with the ability to select networks, operators may proactively seek to use non-HFC pathways as a standard for their monitoring or management communications pathways. With this ability, the operator may want to select Wi-Fi as the primary pathway for monitoring, and cellular as “one of any” alternative paths. This network-selecting functionality allows both primary and backup monitoring communication pathway selection.

One example of how an NS-HFCM could be used as a monitoring device in an HFC network would be as follows. Assume a whole trunk of the cable plant has gone down. The operator does not know the root cause of the problem, whether the coaxial cable was cut, the optical node failed, the fiber cable was cut, the commercial power failed, or the backup power supply (which rectifies and inverts—so not simply passes through—the commercial power) failed. Further, the operator would not know the root cause until someone is sent out to assess the problem. However, the operator needs to determine who should be sent out to assess the problem. Should they send out a technician that specializes on the coaxial side, or one that specializes in fiber? Does the technician need to know how to troubleshoot an optical node or a backup power supply? Or, does the operator need to ask the commercial power company to investigate? Without a communication path (because the trunk has gone dark), nobody knows until someone has gone on site to investigate first hand. Using embodiments of the present invention, the operator can determine what the issue is without sending someone on site, since the monitoring device is able to continue communicating on a separate communication path (and with backup power). Such capability is not possible with currently sold monitoring devices. By utilizing embodiments of the present invention, the operator is able to determine (for example) that the backup supply and commercial power feed are just fine, and thus not the cause of the failure. However, communication has ceased. The operator can also tell that the optical node is fine, so it is either the fiber cable or coax cable. Accordingly, the operator has been able to drastically reduce the possibilities of two possible root causes.

In another example, the same scenario happens (a whole trunk of the cable plant has gone down). Utilizing embodiments of the present invention, the monitoring device is able to report back via the secondary communication path that the backup power supply and commercial power feed are fine, but that the optical node is not working properly. Thus, there is no need to check cables as the root cause of the outage is the optical node.

FIG. 1 provides a logic diagram for network and power selection for the NS-HFCM in accordance with an example embodiment of the present invention. FIG. 2 provides an example of cascading network selection logic (to select between network A and network B) in accordance with an example embodiment of the present invention.

The fifth functional area of the NS-HFCFM is the capability (circuitry and logic) to remain operational despite the loss of power to the monitor itself. Monitoring devices typically receive their power from the HFC network via an AC power supply connected to the coaxial cable. Herein, this is called “HFC networked power” (input 801 in FIG. 3). HFC networked power is obtained from an external power source such as commercial power, energy storage devices (batteries) or generators. Herein this is called the “HFC power source”. The HFC network can fail if the HFC power source fails. In this event, the NS-HFCM uses one of its alternative power sources to provide operational power for a period of time, without reliance on HFC networked power and the NS-HFCM continues to operate and provide monitoring capabilities. The NS-HFCM has one or more alternative power sources available to it and thus does not rely on the HFC networked power for continued operation. The alternative power sources available to the NS-HFCM may include, but are not limited to, an internal energy storage device (e.g., rechargeable battery 803, FIG. 3), an external battery, wind power, or solar power (e.g., via input 802 in FIG. 3). The NS-HFCM may be powered by HFC networked power during normal operation, but will rely on one of its alternative power sources if HFC networked power is not available. As shown in the example embodiment of FIG. 3, the power source or sources (from among 801, 802 and 803) utilized by device 901 is selectable via a power source switch 504 which is controlled via power source switch control 503 communicated by processor core 401.

FIG. 5 provides an example of an HFC network outage that results in use of an alternative communications network (cellular network 202) and alternative power source (rechargeable battery 803). The NS-HFCM may include additional logic to determine from which power source to receive power. This logic is called power logic. Both the power logic and communication logic may be in the same physical space, or part of the same computer code. This is depicted by element 601 in FIG. 3. The power logic may take network and environmental variables into consideration before choosing an appropriate power source.

The selection of the power source type and capacity are based on the policy and power logic, as well as the communication logic. The power selection control is depicted by input 503 in FIG. 3. The power logic is based on the power profile of each NS-HFCM. The power profile required for a NS-HFCM that requires cellular communications will not be the same power profile as a NS-HFCM that requires Wi-Fi communications. In this way, the power logic is tied to, the communication logic.

In the event that HFC networked power is lost, the NS-HFCM alternative power source could also lose power over time to the point where the NS-HFCM would potentially stop functioning. However, if indefinite operation of the NS-HFCM is required, renewable energy such as wind or solar may be utilized in combination with, or instead of, an integrated battery. The aforementioned power logic would include these renewable energy options as well.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

What is claimed is:

1. A device for monitoring a hybrid fiber coaxial network, the device comprising:
a processing device structured to receive data related to the hybrid fiber coaxial network and communicate the data via at least one of a plurality of communication pathways; and
a switching mechanism in communication with, and controlled by the processing device, the switching mechanism structured to select from among the communication pathways the at least one pathway along which the data from the processing device is communicated in accordance with logic carried out by the processing device,
wherein the plurality of communication pathways comprises a communication pathway other than the hybrid fiber coaxial network.

2. The device of claim 1 wherein the logic is one or both of predefined or defined by a user.

3. The device of claim 1 wherein the switching mechanism is adapted to provide for the processing device to communicate along two or more communication pathways of the plurality of communication pathways at the same time.

4. The device of claim 1 wherein the logic relies on one or more variables that may be internal to or external to the monitor in determining the at least one communication pathway along which the data from the processing device is transmitted.

5. The device of claim 4 wherein the one or more variables comprises one or more of: a power supply data point, a network status data point, an environmental data point, or a data point pertaining to a network element being monitored.

6. The device of claim 1 wherein one of the plurality of communications pathways comprises: a cellular phone network, a Wi-Fi network, or an Ethernet network.

7. The device of claim 1 wherein the device further comprises a power source switching mechanism structured to receive power from a plurality of power sources and selectively allow transmission of the power from a selected one of the power sources to the processing device in accordance with the logic; and wherein at least one of the power sources comprises a power source other than the hybrid fiber coaxial network.

8. The device of claim 7 wherein the at least one power source comprises a rechargeable battery or a super capacitor.

9. The device of claim 8 wherein the rechargeable battery is structured to be recharged by the hybrid fiber coaxial network.

10. The device of claim 8 wherein the rechargeable battery is structured to be recharged by at least one of solar power or wind power.

11. The device of claim 1 wherein the processing device includes a device-specific identifier associated therewith and wherein the processing device is structured to communicate the identifier via the at least one communication pathway.

12. A system for monitoring a hybrid fiber coaxial network, the system comprising:
at least one communication pathway other than the hybrid fiber coaxial network;
a monitoring device comprising:
a processing device structured to receive data related to the hybrid fiber coaxial network and communicate the data via at least one of a plurality of communication pathways, the plurality of communication pathways comprising the hybrid fiber coaxial network and at least one communication pathway other than the hybrid fiber coaxial network; and
a switching mechanism in communication with, and controlled by, the processing device, the switching mechanism structured to select from among the communication pathways the at least one pathway along which the data from the processing device is communicated in accordance with logic carried out by the processing device.

13. The system of claim 12 wherein the logic relies on one or more variables that may be internal to or external to the monitor in determining the at least one communication pathway along which the data from the processing device is transmitted.

14. The system of claim 12 wherein the at least one communication pathway other than the hybrid fiber coaxial network comprises at least one of: a cellular phone network, a Wi-Fi network, or an Ethernet network.

15. The system of claim 12 further comprising at least one power source other than the hybrid fiber coaxial network and a power source switching mechanism controlled by the processing device, wherein the power source switching mechanism is structured to receive power from the hybrid fiber coaxial network and the at least one power source other than the hybrid fiber coaxial network and selectively allow transmission of the power from a selected one of the hybrid fiber coaxial network and the at least one power source other than the hybrid fiber coaxial network to the processing device in accordance with the logic.

16. The system of claim 15 wherein the at least one power source other than the hybrid fiber coaxial network comprises a rechargeable battery or a super capacitor.

17. The system of claim 16 wherein the at least one power source other than the hybrid fiber coaxial network is structured to be recharged by one or more of the hybrid fiber coaxial network, solar power or wind power.

18. The system of claim 12 wherein the processing device includes a device-specific identifier associated therewith and wherein the processing device is structured to communicate the identifier via the at least one communication pathway.

19. The system of claim 18 further comprising a network management system which utilizes the common device-specific identifier to combine information or data communicated on two or more communication pathways into one set of information or data.

20. A method of monitoring a hybrid fiber coaxial network, the method comprising:
sensing via a number of electronic sensors one or more characteristics of the hybrid fiber coaxial network; and
communicating the one or more characteristics via a communication pathway other than the hybrid fiber coaxial network.
